(19) United States
(12) Patent Application Publication
(10) Pub. No.: US 2010/0308980 A1
(43) Pub. Date: Dec. 9, 2010

(54) NETWORK ARCHITECTURE FOR WIRELESSLY INTERFACING SENSORS AT ULTRA LOW POWER

(76) Inventors: Geoffroy Pascal M. Gosset, Etterbeek (BE); Denis Flandre, Bruxelles (BE); Gilles Delmee, Ottignies (BE); Bertrand Rue, Ixelles (BE)

Correspondence Address: BACON & THOMAS, PLLC, 625 SLATERS LANE, FOURTH FLOOR, ALEXANDRIA, VA, 22314-1176, US

(21) Appl. No.: 12/863,926

(22) PCT Filed: Jan. 22, 2009
(86) PCT No.: PCT/EP09/50734

§ 371 Date: Jul. 21, 2010

(30) Foreign Application Priority Data
Jan. 22, 2008 (GB) 0801130.6

(51) Int. Cl. G08B 9/00

(52) U.S. Cl. 340/286.02

(57) ABSTRACT

A sensing network is described, consisting of a multiplexing reader and one or more sensor pairs, each sensor pair comprising a transponder and a dedicated reader, dedicated to that transponder, each transponder having a sensor. Each sensor pair is able to wirelessly interface and power both capacitive and resistive sensors at a short distance with high efficiency. By providing a dedicated reader for each transponder, each link can be optimized and there is no need for the dedicated reader to distinguish between signals from other transponders. The transponder generates an analog signal directly using a sensor or analog memory value and sends it by modulation to the dedicated reader. So, the dedicated readers do not need to have circuitry to demodulate a digital signal or ID code. The transponder includes the sensors and their electronic circuits and can be optionally remotely powered by the dedicated reader through the wireless link. The expected consumption of the dedicated reader can be lower than 200 μW.

### TECHNICAL FIELD

The present invention relates to a wireless architecture including sensors, like sensors integrated in a remote tag for example, and methods of making and operating the same. In particular the present invention relates to Micro-Electro-Mechanical-Systems (MEMS), especially MEMS sensors.

### BACKGROUND

There are many situations where it is difficult to measure a physical parameter, for example the temperature in a test-tube without disturbing its content. Indeed, sample volumes inside of it usually being very small, a very small sensor requiring no wired connection, directly plunged into the contents appears as a very elegant and innovative solution in the medical area.

Another portable medical application concerns health monitoring for which a high efficiency is required along with a long range data transfer without perturbing the human body.

In the same way, measurements realized in vacuum can also be very difficult. These measurements can be realized nowadays, but the price to pay is the increased complexity of the measurement apparatus. Indeed, vacuum has to be ensured, despite the cables going from inside chamber to the outside world. The possibility of wirelessly recovering information simplifies the access to data as well as the adaptability of imaginable measurements.

There are also difficulties linked to measurements realized on rotating objects such as shafts. One solution is to make cables run inside the shaft, when it is possible. Another solution requires a reader and a transponder coil located around the shaft, resulting in a bulky solution complex to implement.

Similarly, in structural health monitoring systems, e.g. for buildings or vehicles, temperature, humidity and strain measurements, for example, inside a material are extremely valuable, like in concrete, glass or composites. Furthermore, networks of sensors located at different critical positions of the structure are usually considered.

One key aspect of portable electronic systems is power consumption. Indeed, a high IC (Integrated Circuit) power consumption reduces its autonomy for systems working on batteries and increases its cost. Another concern is sensor size reduction, which leads to a better portability. Indeed, portable sensors are of higher interest than fixed measurement apparatus. The use of MEMS sensors of small size is steadily increasing.

Known solutions for transmitting data use digitally coded data. Some focus on a plurality of modulation types, e.g. FSK, BPSK, QPSK, MSK. Others focus on modulation monitoring, like for example the control of phase variation or the readjustment of phase modulation degree. Finally, some architectures are based on a resonator.

M. R. Haider, S. K. Islam, M. Zhang. Sensors and transducers journal; vol 84 Issue 10, October 2007, pp 1625-1632 describe a system compatible only with resistive MEMS sensors that uses current variation to realize a frequency variation thanks to an integrator and a Schmitt trigger. This signal is then used to modulate a higher frequency signal through a NAND logic gate. This architecture consumes about 400 μW in the transponder part.

Nattapon Chaimanonart, Michael A. Suster, Wen H. Ko, and Darrin J. Young. Two-Channel Data Telemetry with Remote RF Powering for High-Performance Wireless MEMS Strain Sensing Applications. Sensors, 2005 IEEE (digital identifier: 10.1109/ICSENS.2005.1597692) describe a system that is compatible with both resistive and capacitive sensors and that digitally encodes the information before realizing the modulation. This architecture requires a 2 mA current to power the transponder which is an order of magnitude too high to be of interest.

It is known from US 2007/222590 to provide an RFID tag system having a multiplexing reader and several transponders. A sensor in the transponder sends sensing information via the RFID link in the form of a signal having an RFID digital code, digital payload data and an analog frequency shaped modulating signal. Digital and analog decoding and demodulating takes place at the reader and requires different demodulator types.

It is known from US 2007/0182549 to provide a sensor in an RFID transponder. The transponder has an RC or LC clock generator and a logic circuit for generating a serial code sequence which includes a leading code and an identification code, the later being stored in a digital memory array. By this architecture, ID codes are required. The goal of an ID code is to make one reader able to interface and discriminate several transponders.

### SUMMARY OF THE INVENTION

It is an object of the present invention to provide a new architecture that allows for interfacing sensors while limiting or reducing the power consumption and reducing design complexity and size. A first aspect of the invention provides:

A sensor network having a multiplexing reader and one or more sensor pairs, each sensor pair comprising a transponder and a dedicated reader, dedicated to that transponder, each transponder having one or more sensors, sensors being either sensing devices or analog memories, each sensor pair having a wireless interface between the transponder and the dedicated reader, and each of the one or more dedicated readers being coupled to the multiplexing reader, to transmit sensing information from its sensor to the multiplexing reader, the wireless interface being arranged such that the transponder sends sensing information by modulation with an analog signal and the dedicated reader being arranged to receive the sensing information without needing to recognize a digital identifier from its transponder.

By providing a dedicated reader for each transponder, there is no need for the dedicated reader to distinguish between signals from other transponders. Other transponders would be located too far away to cause interference. This means the dedicated readers do not need to have circuitry to demodulate a digital identifier. This enables the dedicated readers to be simpler, cheaper and have lower power consumption. Indeed some of the more complex circuitry or function is moved upstream to the multiplexing reader.

According to another aspect of the invention, the dedicated reader is arranged to send the sensing information to the multiplexing reader in analog or digital form, moreover using an analog or digital ID code. In one embodiment, the analog ID code can be a frequency provided by a free running oscillator. In any case, this effectively moves the optional digital demodulation interface upstream to the multiplexing reader, which brings similar advantages. The wireless interface may be an RF interface of the inductive or capacitive coupling type. The architecture is adapted to send analog data from a transponder to its dedicated reader. This analog data, coming from the transponder, is provided either by one or more sensing devices such as MEMS sensors, or is first retained or stored in a suitable analog memory before transmission. Any suitable memory can be used, e.g. a physical memory such as a capacitance, a resistance or a current value. Preferably this analog data is sent by the transponder to its dedicated reader at a short distance (to reduce power demands), e.g. via an inductive link, and using, on the dedicated reader side the carrier wave (Vin) frequency giving the higher possible efficiency according to the medium separating the transponder and the given dedicated reader. So, the frequency used can be different for each sensor pair in order to optimize the system. The inductive link preferably consumes very low power. The data may be transmitted via amplitude, phase, frequency modulation, or a combination of those for example.

In one embodiment an analog frequency signal is generated as a direct function of the sensing information which can be either the measured parameter analog value given by the sensing device, or the stored or memorized analog value. It can be generated by an oscillator, the frequency of which is controlled by the sensing information to be sent, e.g. a capacitance, a resistance or a current value, provided by a sensing device such as a MEMS sensor or can be obtained from a physical analog memory, i.e. is a previously analog memorized value. The information is recovered in the reader by demodulation. The transponder can be passive, i.e. powered by the dedicated reader through the wireless link or active, i.e. powered by a battery or via an energy scavenging system. The dedicated reader can be powered by any suitable means, e.g. from a battery, via an energy scavenging system, or by the multiplexing reader through an RF link or a wire according to the embodiment for example.

The transponder can be a passive device that is powered via the wireless link. The analog data is an analog frequency shaped signal obtained by direct conversion from the sensor or from a stored or retained analog value, e.g. in some form of physical analog memory.

The sensor can be any kind of device for generating sensing information. Sensing information can encompass for example information about the current or past environmental conditions, current or past state or characteristics or identity of any object, and so on. The sensor can encompass devices such as MEMS sensors for sensing such conditions or characteristics, or a storage device for retaining and outputting an analog representation of past measurements, or a predetermined value representing a characteristic or identity of an object.

The sensing device can be a MEMS sensor and the sensor can be co-integrated with electronic circuitry for processing the signal from the sensor, for providing power to the sensor, etc.

### BRIEF DESCRIPTION OF THE DRAWINGS

FIG. 1 illustrates a system architecture in accordance with an embodiment of the present invention.

FIG. 2 shows a ring oscillator architecture in accordance with an embodiment of the present invention. In FIG. 2a resistive MEMS sensors and in FIG. 2b capacitive MEMS sensors are shown.

FIG. 3 shows a transponder in accordance with an embodiment of the present invention.

FIG. 4 shows a reader in accordance with an embodiment of the present invention.

FIG. 5 shows a reader and transponder electrical equivalent circuit.

FIG. 6 shows a reader and transponder electrical simplified equivalent circuit.

FIG. 7 shows a G(jω) Bode representation in both switch states of an embodiment of the present invention.

FIG. 8 shows the variation of the rectified voltage at the output of the voltage multiplier with the coupling coefficient vs. time of an embodiment of the present invention.

FIG. 9 shows a proposed architecture power balance in accordance with an embodiment of the present invention.

FIG. 10 shows an overview of a sensing network having a number of sensor pairs and a multiplexing reader according to an embodiment.

### DESCRIPTION OF THE ILLUSTRATIVE EMBODIMENTS

Embodiments of the present invention will be described in detail with respect to certain drawings but the invention is not limited thereto. For illustrative purposes, most of the drawings are schematic, therefore, the size of the elements are not drawn to scale. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

The term “comprising”, used in the claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations, relationships, or configurations than the examples described or illustrated herein.

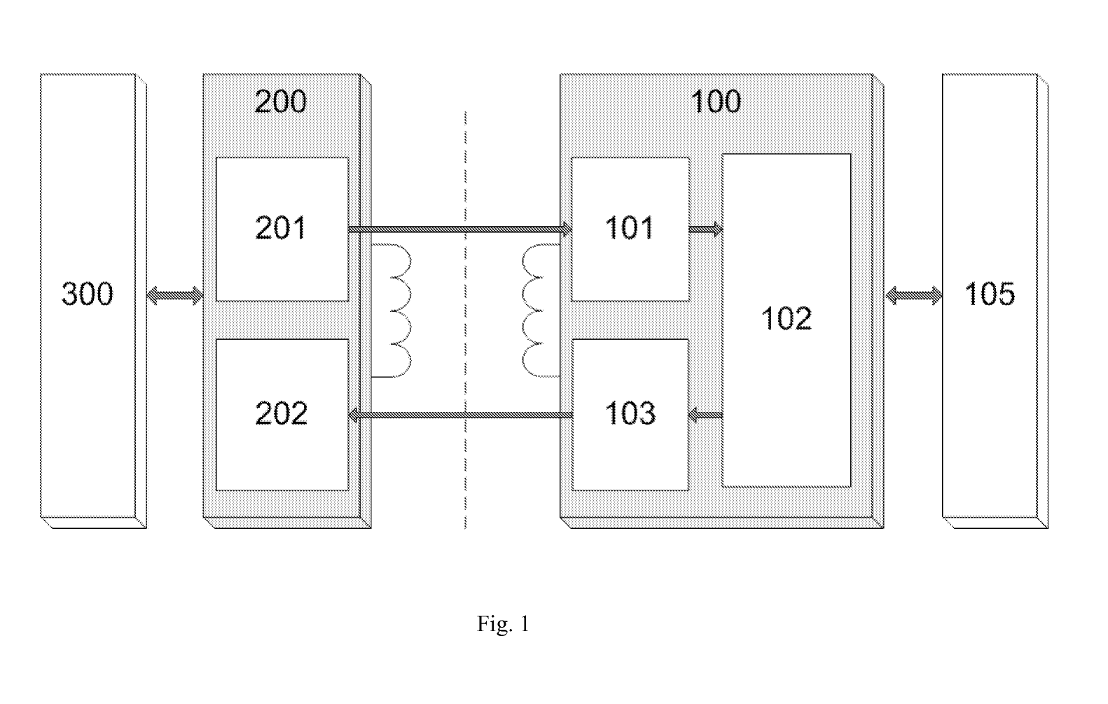

As presented in FIG. 1, a sensor micro-system is made of three parts: a transponder 100 with sensors such as MEMS sensors for example 105, a dedicated reader 200, and a multiplexing reader 300 which can be located locally or remotely, and have a high level data processing unit.

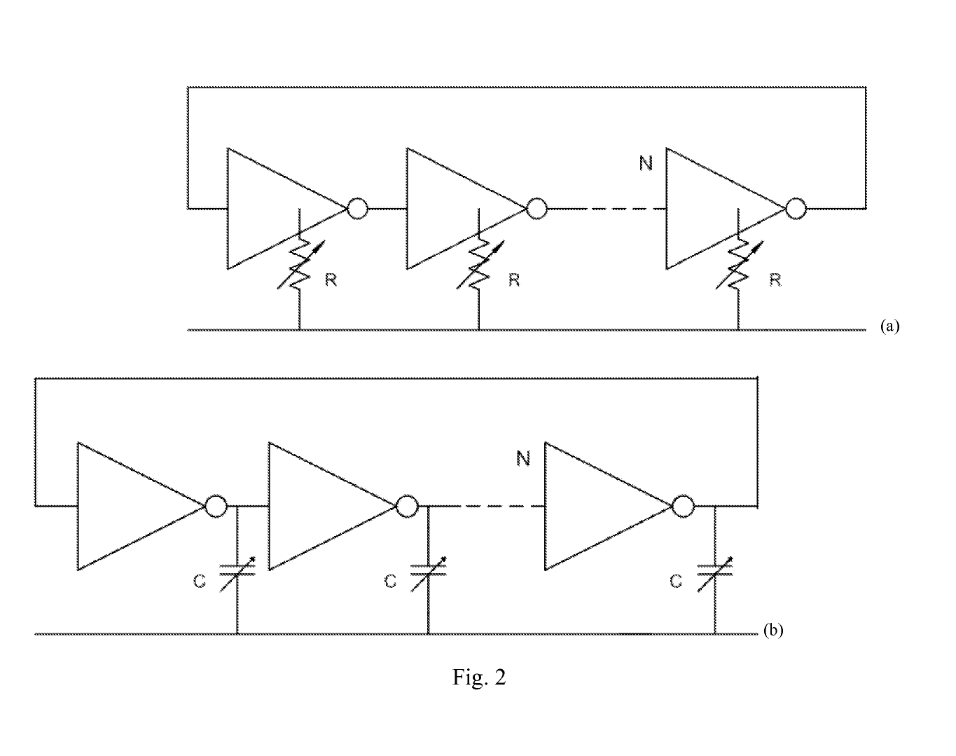

The transponder 100 is the part for providing the data. This part is constituted by one or more MEMS capacitive or resistive sensing devices or analog data retention devices, nominal values of which can be very different. The output value of the sensor, such as a capacitance or resistance of those sensors varies with the measured parameter. These sensor output values such as resistance or capacitance values are then used to modify the oscillation frequency of an oscillator 102. The oscillator can be of any suitable type, as long as its frequency can vary under the effect of the sensor output value such as a resistance or capacitance variation. FIG. 2 shows a kind of ring oscillator that can be used in an embodiment of the proposed architecture. This is constituted by N inverters connected in a ring. The intrinsic frequency is a function of the current (I) driven by the inverters and of the input capacitances (C) of the inverter transistors. Indeed, in this case, the output load of a given inverter is the gate capacitance of the following one and the delay induced by each inverter is approximately given by

$${τ}_{delay} = \frac{C \cdot V}{I}$$

where V is the supply voltage.

Two possible ways to change this delay are either by modifying the intrinsic current driven by the inverter (FIG. 2a) or by modifying the capacitance seen at one or each node (FIG. 2b) for example.

FIG. 2a shows resistive MEMS sensors and FIG. 2b shows capacitive MEMS sensors. As can be seen, a number of sensors can be coupled into a single oscillator, in a time division multiplexed fashion. This can save power compared to having many oscillators. Parts of the ring oscillator can be switched out in any predetermined order using switches not shown. One way for the dedicated reader to know which sensor is connected to the oscillator at a given time is either by knowing when sensors switch on the transponder side. Another way could be by combining sensors and oscillator in such a way that the oscillator output signal frequency is in a different range for each sensor. Any combination of those could also be used.

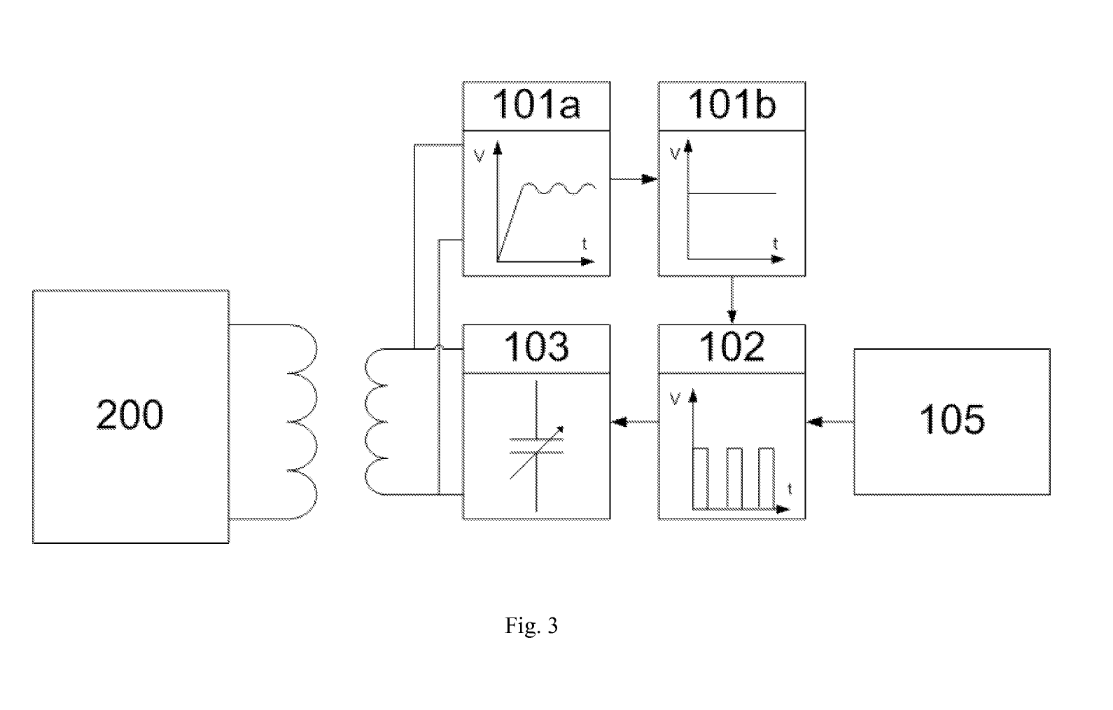

The frequency of the oscillator is commanded by the sensor output values such as capacitance or resistance value variations. The oscillator output signal, being an analog signal, is then used to realize the modulation of the carrier signal sent by the dedicated reader, by varying the transponder's LC tank or an LR tank could be used as well. For reliable data transfer, the capacitance required for modulation can thus be much higher than the sensor capacitance (e.g. by orders of magnitude, pF vs. fF) calling for the sensor interface. Similarly connecting the resistance of a sensor to the inductive coil has been discarded. As shown in FIG. 3, in one embodiment the modulation is made by switching a capacitance (or resistance), which value is big enough considering the resonance frequency of both the dedicated reader and transponder as well as the inductance value of the transponder coil. This capacitance (or resistance) is placed in parallel with the transponder coil. As the output signal of the oscillator is 0 (respectively 1), the capacitance (or resistance) is equal to the equivalent parallel capacitance (or resistance) of the different circuits constituting the transponder. As the output signal becomes 1 (respectively 0), the capacitance (or resistance) is then equal to the equivalent parallel capacitance (or resistance) of the different circuits constituting the transponder plus the value of the capacitance (or resistance) placed in parallel with the coil. It is the frequency at which this capacitive (or resistive) variation is realized that will be recovered in the dedicated reader by demodulation. This frequency (f_{osc}), being a direct function of the parameter value to be measured by a sensor such as a MEMS sensor, the analog data (=the value measured by the sensor) is recovered remotely, and under a frequency shape. F_{osc} can be chosen according to an optimal transfer link for each sensor pair.

FIG. 3 shows the transponder details schematically in accordance with an embodiment of the present invention, in which reference number 101a refers to a rectifier—voltage multiplier, 101b to a voltage regulator, 102 to an interfacing circuit that may be a CMOS MEMS interfacing circuit, 103 to a modulation unit, 105 to sensors such as MEMS sensing devices or analog memories and 200 to the dedicated reader. CMOS processing allows co-integration of the MEMS devices and electronics.

Optionally a frequency divider can be introduced between items 102 and 103 to reduce the power used by part 103 if the oscillator runs faster than desired for the link. The sensing information would remain in the analog domain.

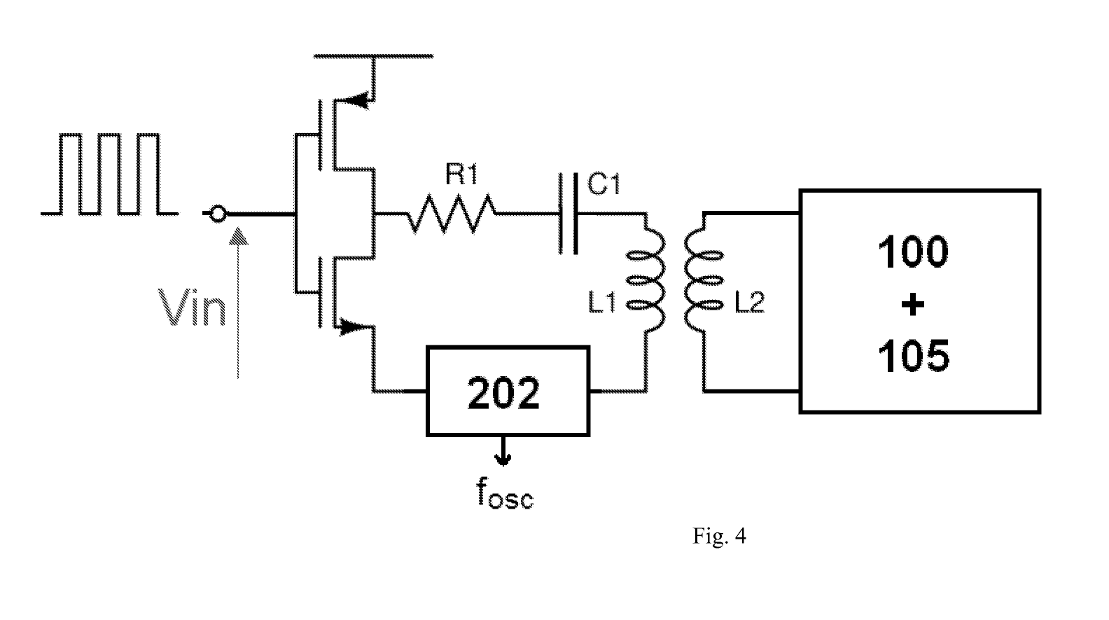

The power can be supplied by the dedicated reader (see FIG. 4), whose system carrier frequency is fixed by an oscillator (Vin), the frequency of which is as independent as possible from external disturbances but is optimized as a function of the medium separating each dedicated reader from its corresponding transponder in order to get a link efficiency as high as possible for each sensor pair and hence the overall system.

Considering its very low electrical power consumption, the dedicated reader 200 can be powered by any suitable method of which via a battery, via a power scavenging system, or by the multiplexing reader through another RF link are only possibilities.

The dedicated reader AC power can be furnished to the transponder through the wireless link or the transponder can have its own power supply such as a battery or a power scavenging system for example. The RF carrier signal (Vin) can be converted to stable DC power by blocks 101a and 101b, for example, for driving the modulation circuit, the transponder oscillator 102, and optionally the sensor 105 (e.g. for resistive sensors). The power management can involve AC signal rectification 101a, and the stabilization of the obtained voltage thanks to a voltage regulator 101b. The dedicated reader can also be used to recover the analog sensor frequency (f_{osc}) being the image of the sensing information, which is the parameter value measured by the sensing device or the memorized analog value. So, the dedicated reader is constituted, along with the power supply, by a demodulation system.

FIG. 4 shows schematically an example of a dedicated reader according to an embodiment of the present invention in which the reference number 100 refers to the transponder 105 to MEMS sensors in the transponder and 202 to a demodulation unit in the dedicated reader. The antenna of the wireless interface is represented by inductances L1 and L2. A pair of transistors is shown to provide an oscillating input voltage (Vin). The changing load on the antenna due to back-scattering from the transponder side causes a varying signal to be detected by the demodulator 202. This outputs a signal representing the sensing information to be sent to the multiplexing reader, along another communication link. This can be an RF link or a wired link for example. If an RF link is chosen, the data is sent through the link by modulation. This modulation takes place in the dedicated reader modulator which is so optional. This modulation can be of any type. In any case, there is no need in the dedicated reader for any circuitry for recognizing an ID from the transponder, nor for demodulating any other kind of digital signal, no framing or timing signals are needed from the transponder, though other additions can be made if desired.

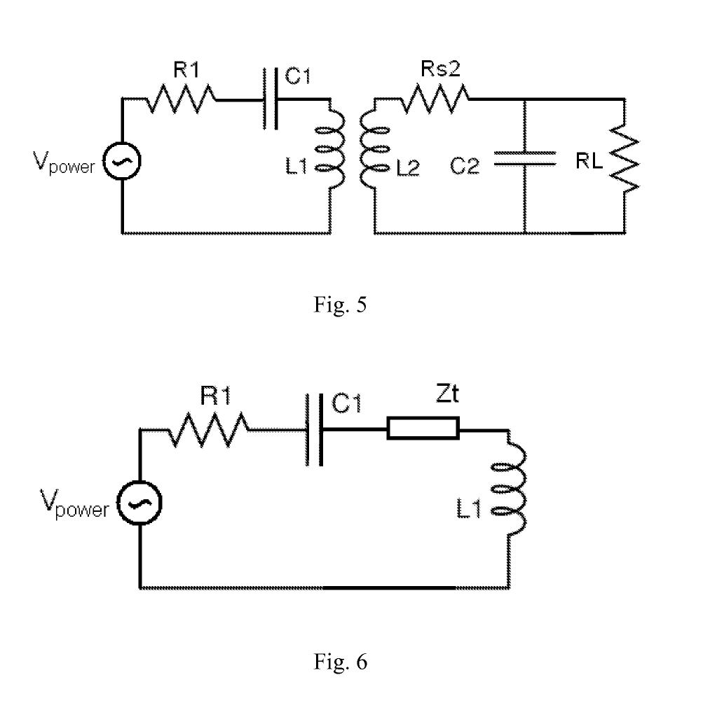

Simulations have been realized using VHDL-AMS language along with ELDO circuit net lists according to an embodiment of the present invention. However, the first simulations that allowed an understanding of the link parameters influence were realized on MATLAB. The system proposed here can be modeled as shown in FIG. 5. In FIG. 5 the dedicated reader and transponder are modeled as an electrical equivalent circuit although other models may be used.

As one can see, the load is constituted of a resistive part (R_{L}), corresponding to the equivalent transponder circuit load and a capacitive one (C₂), leaving the opportunity to choose the modulation type. As previously said, a phase modulation can be used, switching the capacitance instead of the resistance. The main advantages are a higher data rate and a better noise immunity.

This circuit can be simplified to the one shown in FIG. 6. The transponder impedance being brought back to the dedicated reader can be expressed by

$$Zt = \frac{{ω}^{2} {k}^{2} {L}_{1} {L}_{2}}{{R}_{S 2} + jω {L}_{2} + \frac{{R}_{L}}{1 + jω {R}_{L} {C}_{2}}}$$

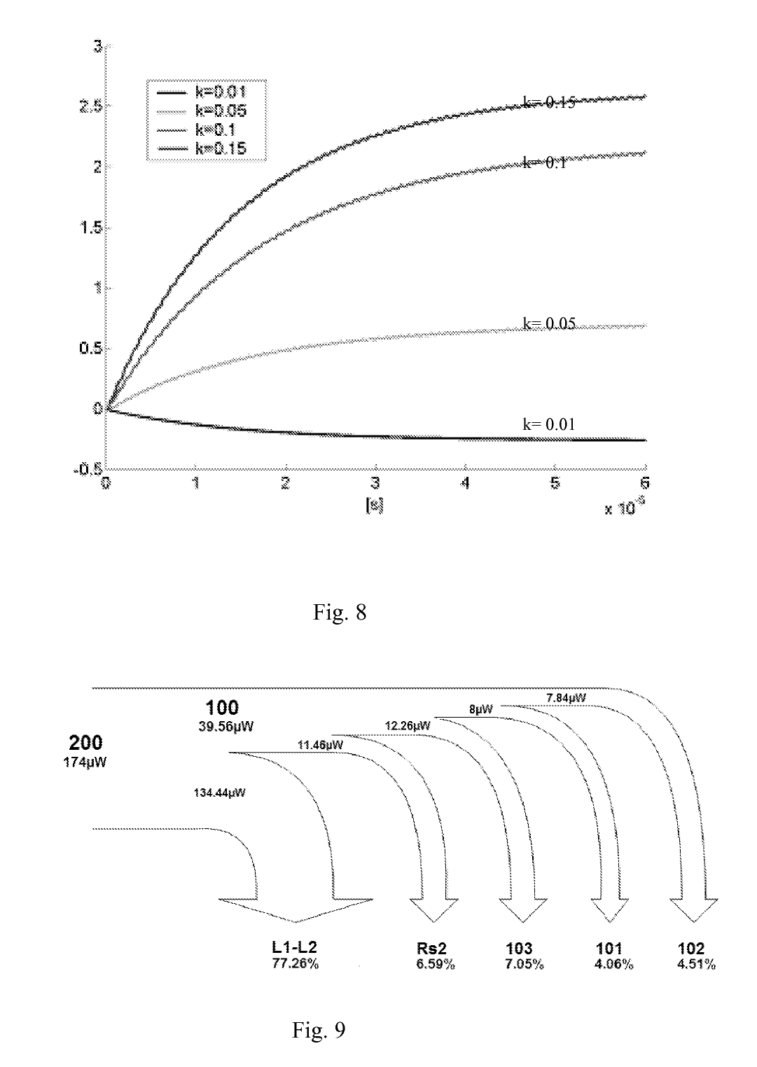

Each of these equation parameters can be optimized according to the application. The carrier wave frequency w can be chosen according to the medium separating the dedicated reader from the transponder in order to optimize the coupling coefficient k. The coupling coefficient is also a function of the distance between coils and the value of the inductances L₁ and L₂ for example. L₁ and L₂ can be chosen in a range of values determined by the application. Finally, C₂ which is equal to the sum of C₂₀ and C_{2switch} has to be chosen according to ω. C₂₀, fixed, is chosen in combination with C_{2switch} according to the amplitude and phase shifts expected. One can see in FIG. 8 the influence of the coupling coefficient, which so calls for the optimization of each link.

In the case of a 13.56 MHz link, a C₂ switch of 8 pF was used which is a compromise between a sufficient and fast enough phase shift while still guarantying a sufficiently low current consumption. Indeed, the switched capacitance has to be charged and discharged fast enough to avoid disturbing the f_{osc} signal frequency which is the image of the sensing information.

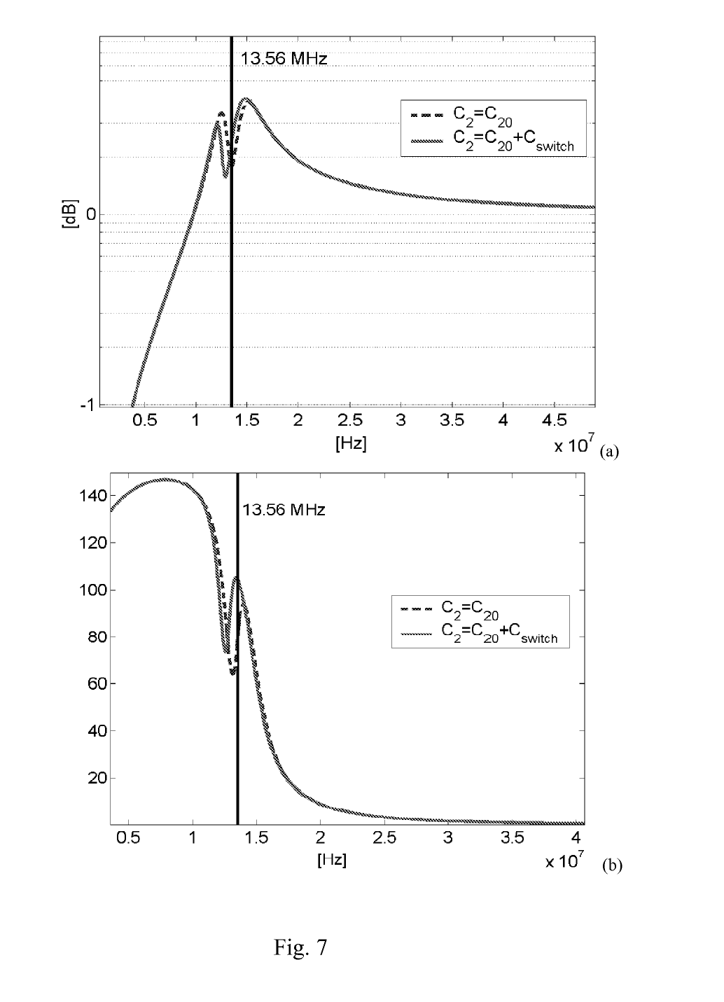

FIG. 7 shows the simulated voltage Bode gain given by

$$G ( jω ) = \frac{{V}_{L 1}}{{V}_{IN}}$$

FIG. 7 shows the G(jω) Bode representation in both switch states, FIG. 7a: gain variation FIG. 7b: phase variation. One can see (FIG. 7a) that it is possible to keep a constant voltage gain by correctly designing the link parameters keeping only the phase shift (FIG. 7b) which is here equal to 25 degrees. The advantage is the reduction of ripple at the rectifier output. However, using phase and amplitude modulation can be interesting to increase demodulation precision.

This phase shift can be recovered by detecting the capacitance switches, which is made by demodulating the signal received from the transponder. Simulations demonstrated that with a coupling coefficient (k) lower than 0.1, the spectral density of the dedicated reader demodulated signal becomes too small to be recovered.

Another point of the architecture to discuss is the optional remote RF powering of the transponder. Indeed, the power can be supplied by the dedicated reader through the wireless inductive link. FIG. 8 shows the variation of the rectified voltage at the output of the voltage multiplier with the coupling coefficient vs. time. As one can see in FIG. 8, the rectified voltage at the output of the voltage multiplier is function of the coupling coefficient. During this first architecture simulation, it was assumed that the voltage regulator 101b requires a constant supply voltage of 1V. This leads, with the 5 stage voltage multiplier used in 101a, to a minimum coupling coefficient of about 0.08.

As described above, the transponder may contain only one integrated generic oscillator able to interface capacitive and resistive sensors. The frequency of the oscillator output signal is a function of the sensing information which is a function of either a selected one of the measured environmental factors or a value provided by an analog memory.

The data transmission from the wireless interface only comprises one section. This section, analog, is obtained by connecting to the backscatter modulator, the signal output of the one transponder oscillator circuit, to which is connected the sensor giving information about the factor of interest. The dedicated reader receives from the transponder a purely analog signal and handles its demodulation in order to retrieve the measured environmental parameter or memorized analog value. At the transponder side the methodology involves creating an oscillating signal having a frequency or pulse width which is a function of the measured environmental parameter or memorized analog value. The signal is then transmitted by the transponder to the dedicated reader by modulation of the carrier signal (Vin), this modulation being either a phase, an amplitude, a frequency modulation, or a combination of those for example directly realized thanks to the output signal of the oscillator.

At the dedicated reader, the methodology involves retrieving the signal sent by the transponder. This signal, purely analog, is obtained by modulation thanks to the output signal of the oscillator. The dedicated reader demodulates the received signal in order to reproduce the oscillator output signal.

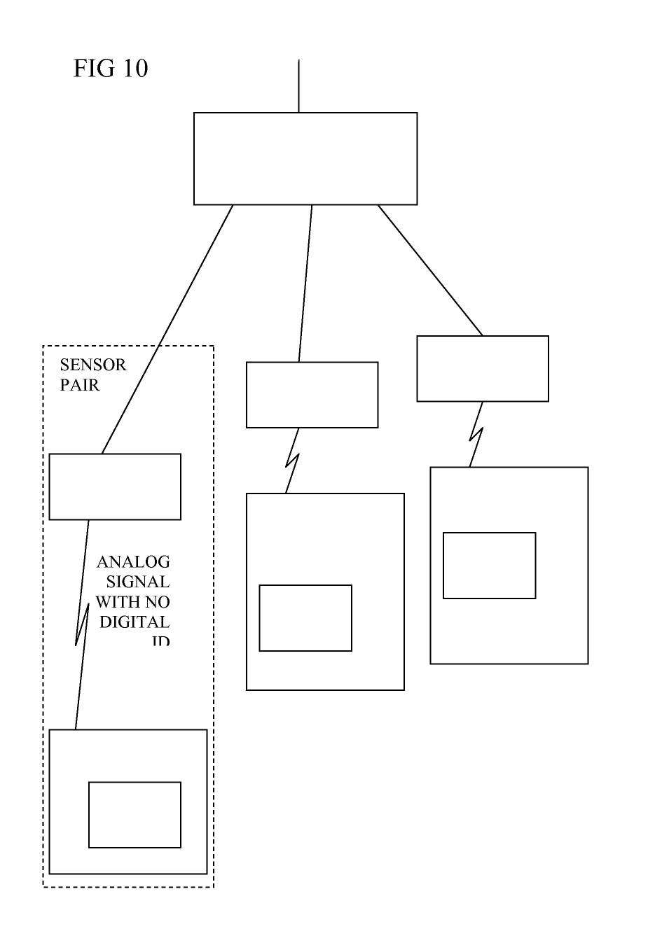

FIG. 10 shows a schematic view of a sensing network according to an embodiment. The architecture of the network can comprise several sensor pairs, each of them having a dedicated reader 200 which can be implemented as described above, interfacing a single transponder 100. Again the transponder can be implemented as described above for example. Each sensor pair is coupled to the multiplexing reader 300. In some embodiments, the portable devices are the dedicated reader and the transponder (sensor pairs) which so aim to consume very low power. Every transponder has one or more sensors 105 and sends its information from its transponder (continuously or not as desired) to the dedicated reader as long as this one is close enough to power it or supplies enough AC power to the link. This means that information is always immediately available. The activation time is thus reduced to its minimum which can mean an additional power reduction on the dedicated reader side. The signal exchanged between the transponder and the dedicated reader only comprises analog data, so the dedicated reader does not need to recognize any digital ID or any digital protocol or digital payload data. Thus, only one simple demodulation system is required, mainly analog, on the dedicated reader side, which is the cause of a major reduction in power consumption. This means both transponder and dedicated reader power consumptions are reduced. In some cases, the sensing information can remain in the analog form up to the multiplexing reader, again to avoid complexity and power consumption in the sensor pairs. To avoid interference, either the sensor pairs can be kept physically out of range of each other, or can use different ranges of frequencies for example.

The power consumption of the wireless link can be reduced by active control of transmit power depending on signal strength for example if the proximity of the transponder changes in use. The rectifier in the transponder can be optimized to have active control of the number of rectifying stages used to get the required voltage to power the regulator for example. Each sensor pair carrier signal frequency (Vin) along with other circuits can be optimized for use in different transmission media such as body (skin, muscles . . . ), liquid or air for example.

The multiplexing reader can be arranged to have a digital interface and to have higher level processing functions for processing the sensing signals into calibrated and labeled values for example. It can also handle transmission and multiplexing protocols for onward transmission of the sensing information to other networks for example. The links from the dedicated readers to the multiplexing reader can be wireless or wired.

The dedicated reader can be considered as being effectively the transponder to the multiplexing reader.

In the above embodiments the modulation is realized through the wireless link using the oscillator output signal. Power sent from the dedicated reader to the transponder can be transformed to power in the transponder circuit. An advantage of the architecture in accordance with some embodiments of the present invention is the ultra low power consumption of the circuits constituting the transponder and the dedicated reader. This leads to an ultra low consumption of the sensor pairs of the system. This is due on one hand, to the network architecture which allows for optimizing each sensor pair for highest efficiency and on the other hand, to the simplification of the information transformation and transmission so as to dispense with digital modulation and demodulation of an ID or any other payload or transmission protocol information for the communication between the dedicated reader and the transponder. Further the required design quality is improved while maintaining the circuit's simplicity. The repartition of the total power in the non optimized circuits is shown on the diagram in FIG. 9 for example.

An architecture of a sensing network for interfacing sensors such as MEMS sensors or other sensors at a long distance and with high efficiency has been described. This system can make use of a remote wireless powering system. First, it is able to send non-digitally coded information at a short distance under a frequency shape depending on sensor value. This analog frequency (f_{osc}) is recovered at the dedicated reader by demodulating the signal received at the dedicated reader inductance terminals. Phase, amplitude or frequency modulation can be used or even a combination of those. The transponder circuits can be supplied at 1V or lower. The sensing information can then be sent over a long distance by the dedicated reader to the multiplexing reader.

A novel architecture has been described able to wirelessly interface and power both capacitive and resistive sensors at a long distance with high efficiency. The sensing part includes the sensors and their electronic circuits and can be optionally remotely powered by the dedicated reader through the wireless link. The dedicated reader can also optionally be remotely powered by the multiplexing reader through an RF link. Using a wireless link (between the dedicated reader and the transponder) at 13.56 MHz, the expected consumption on the dedicated reader side, including power supply and demodulation is lower than 200 μW, and its consumption on the transponder side, including the sensor and its electronics, is less than 40 μW. Even lower power consumption can be expected on both transponder and dedicated reader sides with more advanced implementations.

1. A sensor network having a multiplexing reader and one or more sensor pairs, each sensor pair comprising a transponder and a dedicated reader, dedicated to that transponder, each transponder having at least one sensor, each sensor pair having a wireless interface between the transponder and the dedicated reader, and each of the one or more dedicated readers being coupled to the multiplexing reader, to transmit sensing information from its sensor to the multiplexing reader, the wireless interface being arranged such that the transponder sends the sensing information by modulation with an analog signal representing the information, and the dedicated reader being arranged to receive and recover the sensing information without the need to recognize a digital identifier from its transponder.

2. The sensor network according to claim 1, the wireless interface being optimized for each sensors pair.

3. The sensor network according to claim 1, the wireless interface being an inductive link.

4. The sensor network according to claim 1, the coupling between dedicated readers and the multiplexing reader being an RF or wired link.

5. The sensor network according to claim 1, the sensor being either a sensing device or a physical analog memory.

6. The sensor network of claim 5, the sensing information being provided directly by the sensor.

7. The sensor network according to claim 1, wherein the sensor is resistive or capacitive, the sensing information from the sensor being a capacitance, a resistance or a current value.

8. The sensor network of claim 1, wherein the sensor is co-integrated with electronic circuitry for processing the sensor sensing information, to generate the analog signal from the sensor, and/or with electronic circuitry for providing power to the sensor.

9. The sensor network of claim 1, wherein sensing devices are MEMS sensors.

10. The sensor network of claim 1, the analog signal from the sensor being a frequency shaped one.

11. The sensor network of claim 10, wherein the frequency shaped analog signal is made by an oscillator, the frequency of which is controlled by the sensing information to be sent.

12. The sensor network of claim 11 wherein the oscillator is a ring oscillator.

13. The sensor network of claim 1, wherein the modulation is either a phase, an amplitude, or a frequency modulation, or even a combination of those.

14. The sensor network of claim 1, wherein the sensing information is recovered in the dedicated reader by demodulation of the received modulated signal containing the analog signal.

15. The sensor network of claim 1, wherein the dedicated reader is arranged to send the sensing information to the multiplexing reader in analog or digital form, moreover using an analog or digital ID code.

16. The sensor network of claim 15, the analog ID code being a frequency provided by a free running oscillator.

17. The sensor network of claim 1, wherein the transponder is passive and is powered from the dedicated reader through the wireless interface, or active and is powered by a battery or via an energy scavenging system.

18. The sensor network of claim 1, wherein the dedicated reader is powered by a battery, via an energy scavenging system, or from the multiplexing reader through an RF or wired interface.

19. The sensor network of claim 1, wherein the transponder comprises a rectifier-voltage multiplier, a voltage regulator, a modulation unit and a sensor interface and the one or more sensors or physical analog memories.

20. The sensor network of claim 14, wherein the dedicated reader comprises a demodulation circuit, a capacitance and an input for receiving a signal from the transponder.

21. The sensor network of claim 1, wherein the power consumption of the transponder is less than 40 μW at 13.56 MHz.

22. The sensor network of claim 1, wherein the power consumption of the dedicated reader is lower than 200 μW at 13.56 Mhz.

23. The sensor network of claim 1, an output of the transponder being a modulated signal, the modulation being realized by directly using an analog frequency shaped signal, the frequency shaping being provided by a controllable oscillator, the frequency of which is controlled by the sensing information from the sensor, the sensing information being a capacitance, a resistance or a current value.
